(19) United States
(12) Patent Application Publication
(10) Pub. No.: US 2016/0290623 A1
(43) Pub. Date: Oct. 6, 2016

(54) WATERTIGHT MODULAR LIGHTING FIXTURE

(71) Applicant: William F. Harris, JR., (US)

(72) Inventors: William F. Harris, JR., Charlotte, NC (US); Thomas L. Jones, Clover, SC (US); Vincent Worley, Charlotte, NC (US)

(21) Appl. No.: 14/678,436

(22) Filed: Apr. 3, 2015

(51) Int. Cl. F21V 31/00; F21V 17/10; F21V 23/02; F21K 99/00

(52) U.S. Cl. CPC F21V 31/00; F21K 9/30; F21K 9/50; F21V 17/101; F21V 23/023; F21K 9/90; F21Y 2101/02

(57) ABSTRACT

A lighting fixture is provided in which several of the components, and in some cases all of the components, that make up the lighting fixture are held together without the use of mechanical fasteners. Rather, pieces of adhesive tape that are cut to have various sizes and shapes according to the size and shape of the components to be adhered to each other may be used to secure the components in an assembled configuration. Use of adhesive as opposed to mechanical fasteners reduces the weight of the lighting fixture, and the sizing and positioning of the tape between certain components can eliminate the need to use a separate gasket or seal between those components, while at the same time producing a watertight lighting fixture. In addition, the adhesive can act as a thermal interface and conduit for the dispersion of heat, thereby maximizing the operating life of the lighting fixture.

### BACKGROUND

Lighting fixtures are used in various contexts and situations to provide light so that people can work and play when there is no natural light available, such as after sunset or in rooms having no windows or access to natural light. In some environments, such as aboard aircraft and water vessels, for example, the weight of every component and device carried by the aircraft or vessel may be important to the functioning or efficacy of the aircraft or vessel. Moreover, the construction of such vessels and the components or equipment thereon may be strictly governed by certain industry or organizational codes or standards, which may dictate that certain requirements be met by the vessel as a whole and/or the individual components installed thereon.

Accordingly, there is a need to provide lighting fixtures that are versatile and can be used in various scenarios, while also meeting certain requirements, for example regarding watertightness or weight.

### BRIEF SUMMARY

Embodiments of the invention described herein provide a light emitting diode (LED) lighting fixture that is assembled solely using adhesive or other non-mechanical fastening techniques and is thus lightweight and watertight.

A lighting fixture according to embodiments of the invention is thus provided that comprises a support plate, a housing, a circuit board, and a lens. The support plate comprises a first surface and a second surface, and the housing is attached to the first surface of the support plate and is configured to receive a power supply. The circuit board is configured to support a plurality of light emitting diodes, and the circuit board is attached to the second surface of the support plate. The lens is attached to the second surface of the support plate, such that the circuit board and the light emitting diodes supported thereby are disposed between the support plate and the lens. The attachment of each of the housing and the lens to the support plate is accomplished without the use of mechanical fastening, and the attachment of each of the housing and the lens to the support plate provides a watertight lighting fixture. The attachment may, in some cases, be accomplished using adhesive. In some cases, the attachment of the circuit board to the support plate may also be accomplished without the use of mechanical fastening, such as by using adhesive.

In some embodiments, the lighting fixture may further include at least one mounting bracket attached to the support plate, where the at least one mounting bracket is configured to secure the lighting fixture in an operational position, and where attachment of the mounting bracket to the support plate is accomplished without the use of mechanical fastening. In other embodiments, the support plate may define at least one mounting hole, and each mounting hole may be configured to receive a fastener for flush-mounting the lighting fixture to a ceiling.

The support plate may, in some cases, comprise an access opening configured to allow passage of electrical wiring from the power supply to the circuit board. The access opening may be a first access opening, and the support plate may further comprise a second access opening configured to allow passage of the electrical wiring from the power supply to a second lighting fixture, such that the power supply is enabled to provide power to multiple lighting fixtures in series. The power supply may be attached to the first surface of the support plate via adhesive.

The lighting fixture may also include two end caps configured to receive respective ends of the lens. Each end cap may be attached to the second surface of the support plate via adhesive and may be attached to the respective end of the lens via ultrasonic welding, epoxy, or adhesive.

The housing may, in some cases, comprise a U-shaped body and two end plates. Each end plate may be attached to a respective end of the U-shaped body to form an enclosure of the housing, and each end plate may be attached to the respective end of the U-shaped body via adhesive.

In other embodiments, a method of manufacturing a lighting fixture is provided, where the method includes attaching a housing to a first surface of a support plate. The housing may be configured to receive a power supply. Additionally, a plurality of light emitting diodes may be connected to a circuit board, and the circuit board may be attached to a second surface of the support plate. A lens may be attached to the second surface of the support plate, such that the circuit board and the light emitting diodes supported thereby are disposed between the support plate and the lens. The attachment of each of the housing and the lens to the support plate is accomplished without the use of mechanical fastening, and the attachment of each of the housing and the lens to the support plate provides a watertight lighting fixture.

In some cases, the power supply may be attached to the first surface of the support plate prior to attaching the housing to the support plate. Additionally or alternatively, attaching the housing, the circuit board, and the lens to the support plate may comprise applying adhesive strips to adhere each of the housing, the circuit board, and the lens to the support plate.

In some embodiments, at least one mounting bracket may be attached to the support plate, where the at least one mounting bracket is configured to secure the lighting fixture in an operational position, and where attachment of the mounting bracket to the support plate is accomplished without the use of mechanical fastening. In other embodiments, at least one mounting hole may be created in the support plate, where the mounting hole is configured to receive a fastener for flush-mounting the lighting fixture to a ceiling.

In some cases, an access opening may be created in the support plate, where the access opening is configured to allow passage of electrical wiring from the power supply to the circuit board. The access opening may be a first access opening, and the method may further comprise creating a second access opening in the support plate to allow passage of the electrical wiring from the power supply to a second lighting fixture, such that the power supply is enabled to provide power to multiple lighting fixtures. Additionally or alternatively, an end cap may be attached to each end of the lens via ultrasonic welding, epoxy, or adhesive.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIGS. 1A and 1B show perspective views of an assembled lighting fixture according to an example embodiment;

FIG. 2 is perspective view of a support plate of the lighting fixture from a first surface-viewpoint according to an example embodiment;

FIG. 3 is perspective view of the support plate of FIG. 2 from a second surface-viewpoint according to an example embodiment;

FIG. 4 is a perspective view of a housing of the lighting fixture in an assembled configuration according to an example embodiment;

FIG. 5 is an exploded perspective view of the housing of FIG. 4 according to an example embodiment;

FIG. 6 is a perspective view of the support plate from a second surface-viewpoint with a circuit board having LEDs attached according to an example embodiment;

FIG. 7 is an exploded perspective view of the support plate and the circuit board with LEDs of FIG. 6 according to an example embodiment;

FIG. 8 is a perspective view of the support plate from a second surface-viewpoint with a lens and end caps attached according to an example embodiment;

FIG. 9 is an exploded perspective view of the support plate, lens, and end caps of FIG. 8 according to an example embodiment;

FIG. 10 is a perspective view of the support plate from a first surface-viewpoint with mounting brackets attached according to an example embodiment;

FIG. 11 is an exploded perspective view of the support plate and mounting brackets of FIG. 10 according to an example embodiment;

FIGS. 12A and 12B are perspective views of an assembled flush-mountable lighting fixture according to another example embodiment; and

FIG. 13 is a perspective view of the lighting fixture of FIG. 12B with the housing removed for purposes of explanation.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the present invention generally relate to an electronics assembly, and more specifically a solid state lighting system, and the methods and devices used in that assembly to maintain structural integrity and meet certain requirements for specialized applications including use in military applications, such as in submarine environments. Embodiments of the invention, for example, include level particle ingress protection to a degree that renders the assembly watertight at a minimum water depth of 3 feet. As discussed in greater detail below, a number of structurally bonding adhesive strips, cut to various lengths and widths, are used to form a hermetic and structural bond between various components of the lighting fixture. Accordingly, the lighting fixture is put together strictly using non-mechanical fastening techniques, which, in addition to creating a watertight lighting fixture, also minimizes the weight of the lighting fixture.

For example, in conventional lighting fixtures, it is standard practice to use mechanical fasteners of some type to attach components of the lighting fixture, and in particular vertically aligned components, to each other to overcome the tendency of the components to separate due to gravitational forces over time. Use of mechanical fasteners, such as screws, bolts, nuts, rivets, pins, clamps, hooks, and other fasteners, however, increases the weight of the lighting fixture and, in some cases, increases the complexity of manufacture and/or assembly. For example, gaskets or other types of seals may need to be used in conventional lighting fixtures to provide the level of watertightness required for certain specialized applications.

In contrast, embodiments of the invention described herein uses adhesive (e.g., double-sided adhesive tape) that bonds with the separate components of the lighting fixture with sufficient force such that gravity will not affect the bond over the life of the product. In addition to maintaining the components joined to each other, the adhesive creates a watertight barrier where it is applied, thus serving a two-fold purpose.

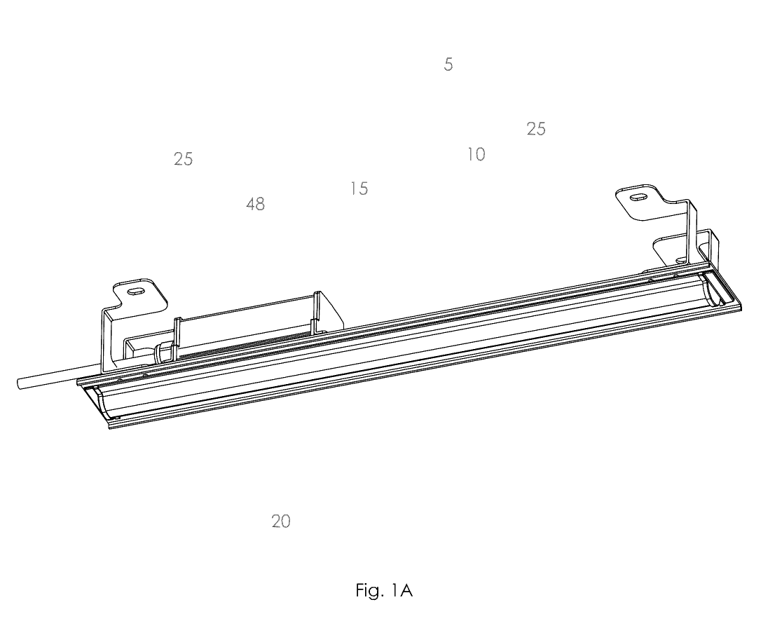

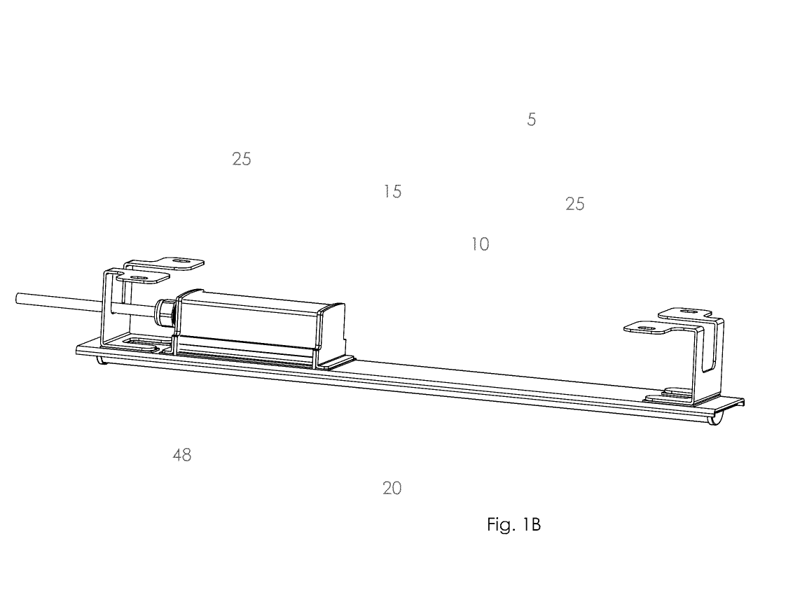

In addition to the benefits mentioned above, embodiments of the lighting fixture described herein are configured to be scalable. For example, although FIGS. 1A-11 depict a single lighting fixture that includes a single lamp or lens deployed as a stand-alone source combined with the power electronics housing, multiple single lighting fixtures may be connected to each other such that a single power supply housed in the power electronics housing of one may be used to provide power to two or more lamps in the connected arrangement, as long as the power supply is sized to accommodate the power needs of the multiple connected lighting fixtures. Moreover, different sizes of the support plate described below may be used to hold multiple lamps on the same lighting fixture, either in series (e.g., using a 4-foot long support plate rather than a 2-foot long support plate) or in parallel (e.g., using a 9-inch wide support plate rather than a 4.5-inch wide support plate). In comparison to creating entirely new lamps for each size, the scalability of the design described herein provides a more economical and simpler way to offer design variations to address a customer's unique needs. Furthermore, embodiments of the multi-lamp lighting fixture may also be configured to provide variation in the color and intensity of the light provided from lamp to lamp.

To facilitate scalability of the lighting fixture while also providing a watertight structure that uses a material-minimized horizontal frame, the electrical connections between the light engines and the power electronics in the power electronics housing are made according to embodiments of the present invention within an enclosure created between the housing, the support plate, and/or the lens. In this way, embodiments of the present invention create a unique light-weight and environmentally sealed luminaire.

Turning now to FIGS. 1A and 1B, a lighting fixture 5 according to embodiments of the invention is shown. The lighting fixture 5 includes a support plate 10, a housing 15, a circuit board (not visible in FIGS. 1A and 1B), a lens 20, and, in some embodiments, at least one mounting bracket 25. Notably, attachment of each of the housing 15, the lens 20, and the mounting bracket 25 (where included) to the support plate 10 is accomplished without the use of mechanical fastening, such as without the use of bolts, screws, pins, or other fasteners. Attachment of the housing and the lens to the support plate, such as by using adhesive (e.g., adhesive tape) alone, can thus provide a watertight lighting fixture, as described herein.

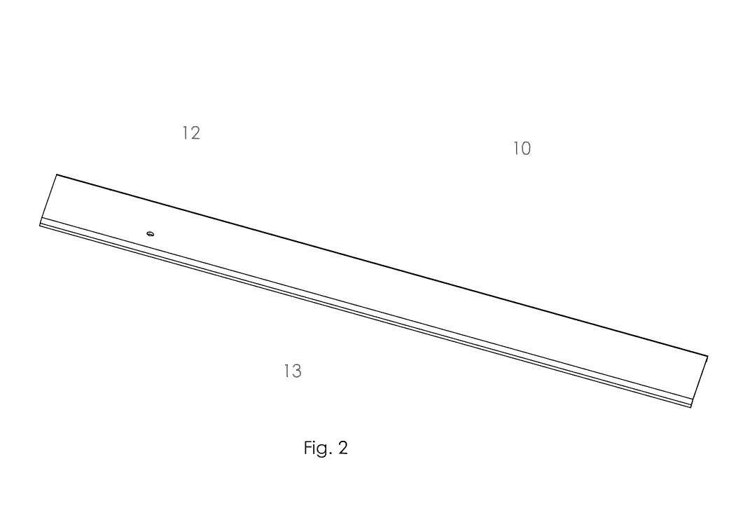

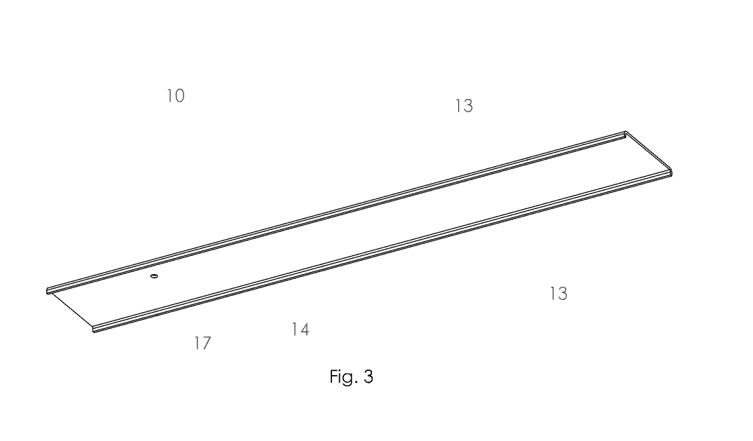

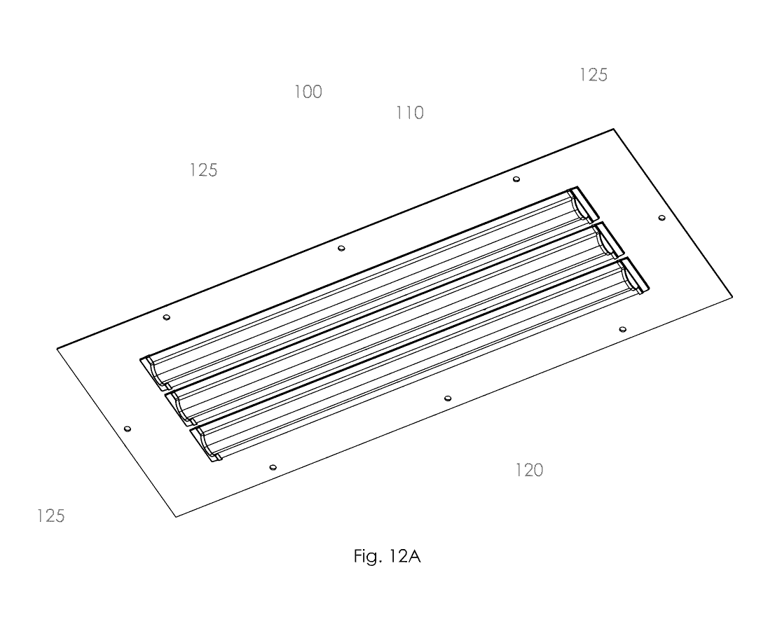

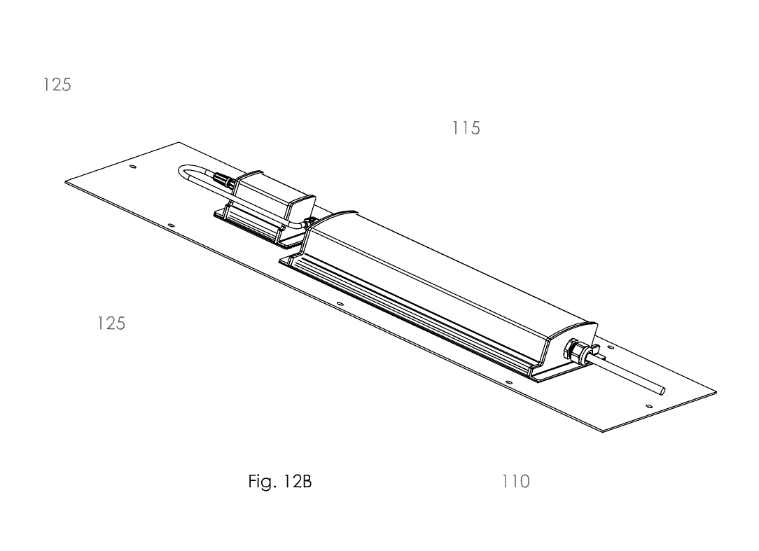

The support plate 10 according to one embodiment is shown in FIGS. 2 and 3. In this regard, the support plate 10 may comprise a first surface 12 (shown in FIG. 2) and a second surface 14 (shown in FIG. 3). The support plate 10 may be made of material such as aluminum, steel, copper, or some types of plastic or rubber with a sufficient thermal conductive properties to serve as a heat sink for the light emitting diodes (LEDs) supported by the support plate, as described below. In the depicted embodiment, the support plate 10 is configured (e.g., sized and shaped) to support a single lamp (e.g., a single circuit board with LEDs). For example, in the depicted embodiment, the support plate 10 may be approximately 4 to 5 inches wide and approximately 2 feet long. In other embodiments, one of which is shown in FIG. 12, for example, the support plate 10 may be wider (e.g., approximately 8-10 inches wide) and/or longer (e.g., approximately 4 feet long) to accommodate other sizes or types of lamps or multiple lamps (e.g., two circuit boards with LEDs connected in series). In addition, in the depicted embodiment, the support plate 10 includes rounded lateral edges 13. The rounded lateral edges 13 may provide the support plate 10 with additional strength to support the components that are attached to the support plate, for example as compared to a plate of the same thickness and overall dimension having straight (e.g., not rounded) lateral edges.

The various components of the lighting fixture 5 may be attached to the support plate 10 via the first or second surface 12, 14. For example, the housing 15, which may be a power electronics housing that is configured (e.g., sized and shaped) to receive a power supply (not shown), may be attached to the first surface 12 of the support plate 10, as shown in FIGS. 1A and 1B. In particular, the housing 15 is attached to the support plate 10 without the use of mechanical fastening techniques, such as by using adhesive (e.g., adhesive tape).

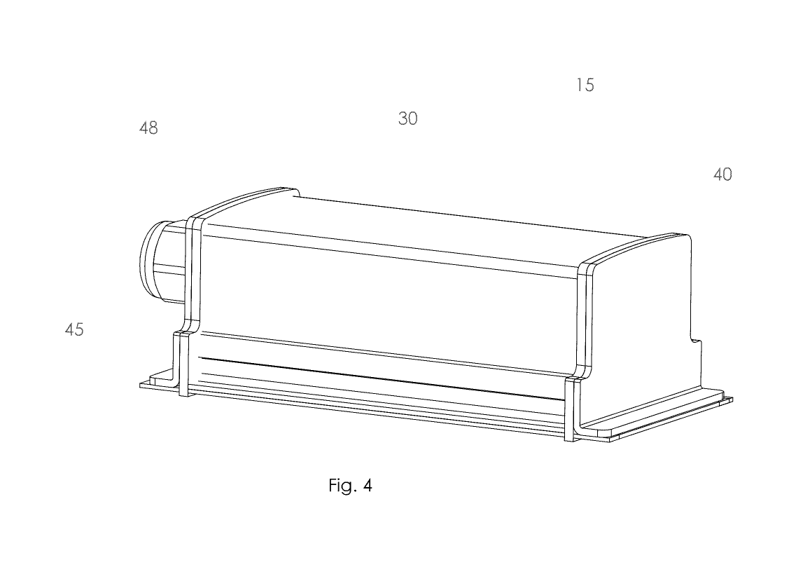

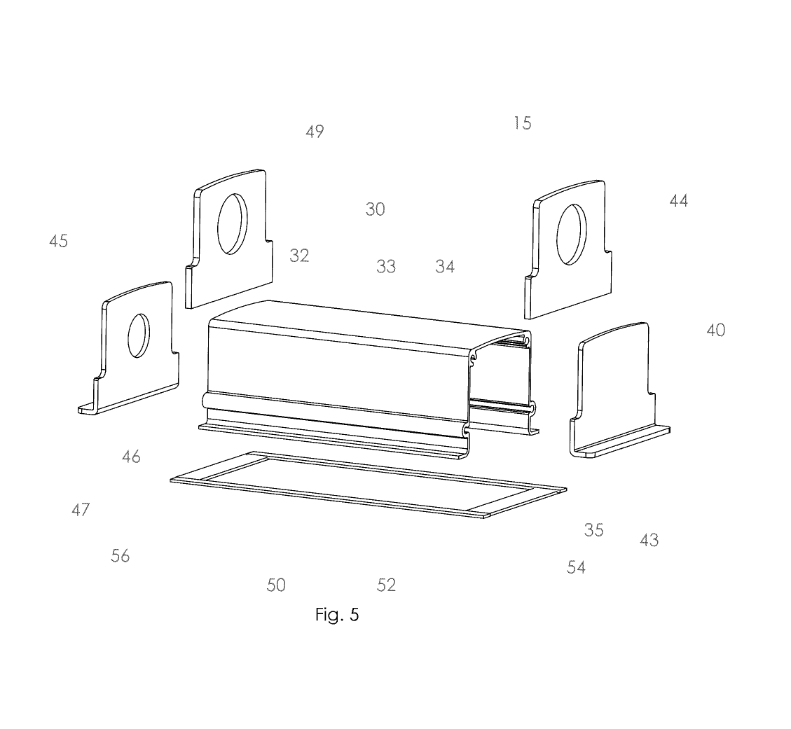

The housing 15 is shown in FIG. 4 in an assembled configuration according to one example embodiment, and an exploded view of the housing 15 is shown in FIG. 5. According to the depicted embodiment, the housing 15 may comprise a U-shaped body 30 that defines two side walls 32, 34 and a connecting wall 36 extending between the two side walls. The housing 15 may further comprise two end plates 40, 45, where each end plate is configured to be attached to a respective end of the U-shaped body 30 (e.g., an open end, as shown) to form an enclosure of the housing, within which the power supply can be disposed. In some cases, one of the end plates 40 may be configured to be a solid piece of material having no holes, whereas the other of the end plates 45 may be configured to include an opening 46, through which a cable gland 48 (shown in FIGS. 1A and 1B) may be positioned to allow a cable to enter the housing 15, such as to provide power from an electrical outlet to the power supply enclosed therein. The U-shaped body 30 and/or the end plates 40, 45 may be made of aluminum, steel, copper or some types of plastic or rubber with a sufficient surface energy.

In this regard, the surface energy of the material may be an indication of how well an adhesive will adhere to it. The higher the surface energy, the more likely it is that an adhesive will function properly. As an example, polypropylene (PP) plastic generally has a very low surface energy. Therefore, to effectively adhere something to a PP plastic material, one must typically treat the surface of the material with chemicals or use a flame to increase its surface energy. In comparison, polycarbonate (PC) and polymethyl methacrylate (PMMA) both deliver significantly higher surface energies, so painting or making something stick to materials made of PC or PMMA is significantly easier than it is with PP. When metal is used, the metal must often have primer applied to it to increase the surface energy so as to allow paints to adhere to the surface of the metal.

In some embodiments, each end plate 40, 45 may be attached to the respective end of the U-shaped body 30 using adhesive, such as via adhesive strips. For example, an adhesive sheet 44, 49 may be cut to correspond to each end plate 40, 45 and sandwiched between the end plates and the respective end of the U-shaped body 30 to form the enclosure of the housing 15, as shown in FIGS. 4 and 5. The adhesive 44, 49 may, in some cases, form an adequate gasket to prevent the ingress of water into the housing 15, so as to serve as a gasket. Thus, in some embodiments, no additional gaskets or seals are needed to produce a watertight enclosure of the housing 15.

In addition, adhesive may be used to attach the housing 15 to the first surface 12 of the support plate. For example, four strips 50, 52, 54, 56 may be applied between flanged edges 33, 35 of the U-shaped body 30 and the first surface 12 of the support plate 10, as well as between the flanged edges 43, 47 of the end plates 40, 45, respectively, and the first surface 12 of the support plate 10. In this regard, the adhesive strips or tape may be cut to the appropriate lengths and widths to provide a sufficient area of engagement between the components to be joined. Likewise, the flanged edges 33, 35, 43, 47 may be sized so as to provide an area of engagement that results in an adhesive force capable of holding the respective component to the first surface 12 of the support plate.

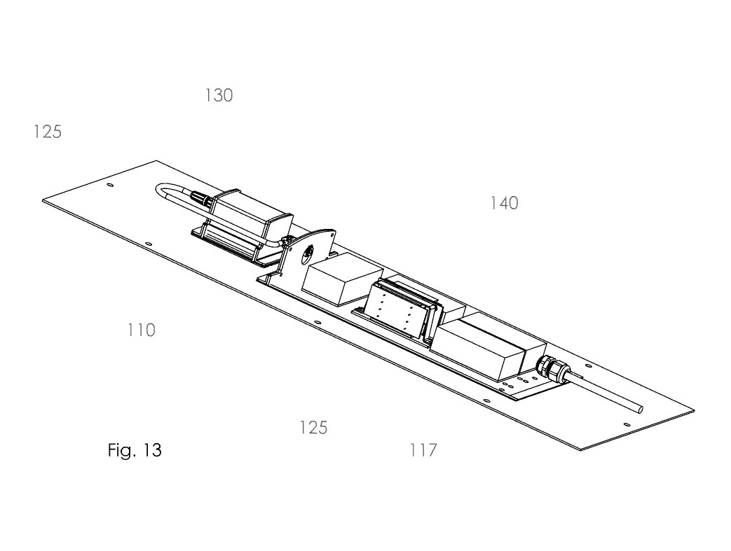

With reference to FIG. 2, in some embodiments, the power supply (not shown) may also be attached to the first surface 12 of the support plate 10, such as prior to assembly of the housing 15 and attachment of the housing 15 to the support plate 10, such as via adhesive. The power supply may include one or more components, such as a transformer assembly, a rectifier, a filter, and/or a regulator circuit, etc. (an example is shown in FIG. 13). In this regard, one or more adhesive strips may be used to adhere the power supply to the first surface 12 of the support plate 10 in the appropriate location, after which the U-shaped body 30 and the end plates 32, 34 may be attached to each other via adhesive 44, 49 and attached to the support plate 10 via additional adhesive 50, 52, 54, 56.

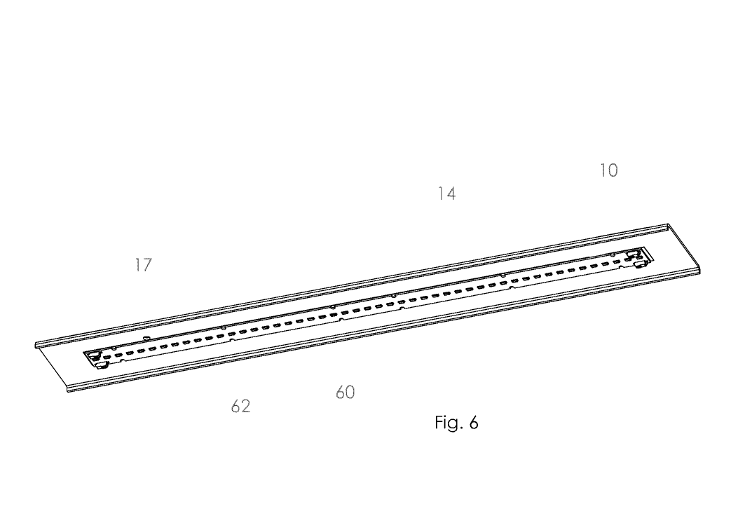

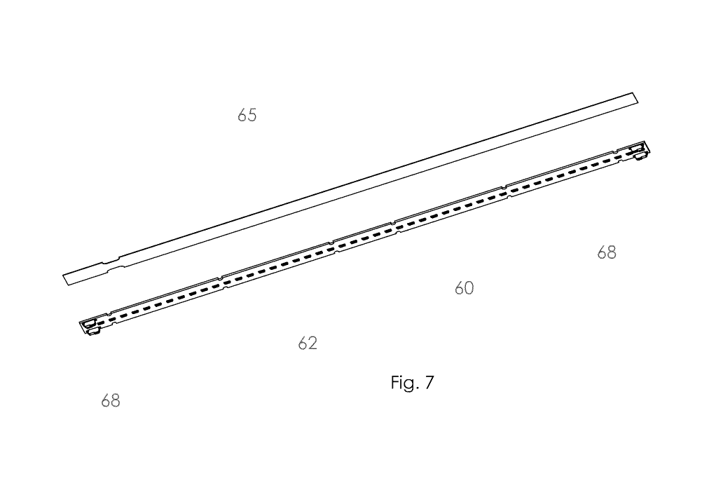

Turning to FIGS. 6 and 7, a circuit board 60 is shown that is configured to support a plurality of LEDs 62. The circuit board 60, in some embodiments, is attached without the use of mechanical fastening (e.g., without mechanical fasteners, such as via adhesive) to the second surface 14 of the support plate 10. An adhesive strip 65, shown in FIG. 7, for example, may be used to attach the circuit board 60 with LEDs 62 to the second surface 14 of the support plate 10, as shown. The adhesive strip 65 may be cut to correspond to the approximate length and width of the circuit board 60, in some cases. In addition to providing the adhesive force to keep the circuit board 60 attached to the support plate 10, the adhesive strip 65 may also act as a thermal interface, conducting heat from the circuit board to the support plate to allow the support plate to act as a more efficient heat sink.

To provide an electrical connection between the power supply housed in the housing 15 and the LEDs 62 on the circuit board 60, an access opening 17 may be provided on the support plate 10 that is configured to allow passage of electrical wiring from the power supply to the circuit board, illustrated in FIGS. 3 and 6. In addition, in some embodiments, the circuit board 60 may include at least one wire terminal 68 that is configured to receive at least some of the electrical wiring (e.g., the wiring provided from the power supply via the access opening 17) for connecting the plurality of LEDs to the power supply. In the depicted embodiment, for example, four wire terminals 68 are provided.

Although a single access opening 17 is shown in the depicted embodiment, in some embodiments the access opening 17 is a first access opening, and the support plate 10 may further comprise a second access opening, such as at the other end of the support plate, that is configured to allow passage of the electrical wiring from the power supply to a second lighting fixture, such that the power supply is enabled to provide power to multiple lighting fixtures. In this way, additional lighting fixtures (which may not have their own power supply), may be electrically connected to a single lighting fixture having a power supply that is sized large enough to provide sufficient power to operate the connected lighting fixtures. The second access opening may be disposed in a location on the support plate that underlying the housing (e.g., inside the housing profile) to preserve water tightness as described above. In cases in which the second access opening is outside the housing profile, a gasket and/or connector system of sufficient water tightness must be used to allow the wires to leave the housing, pass through the support plate, and be routed to the other lighting fixture(s) without providing a pathway for moisture to enter the system. Either way, in this scenario, the lighting fixtures would be aligned lengthwise, such that connections between adjacent lighting fixtures are made in series.

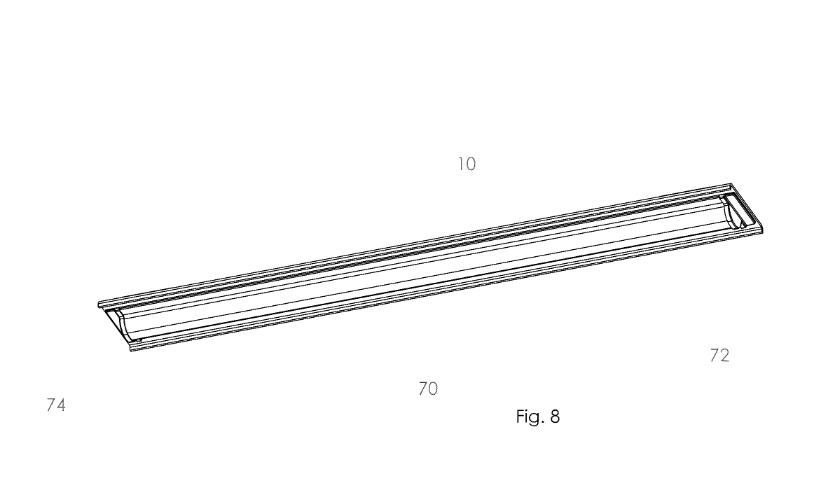

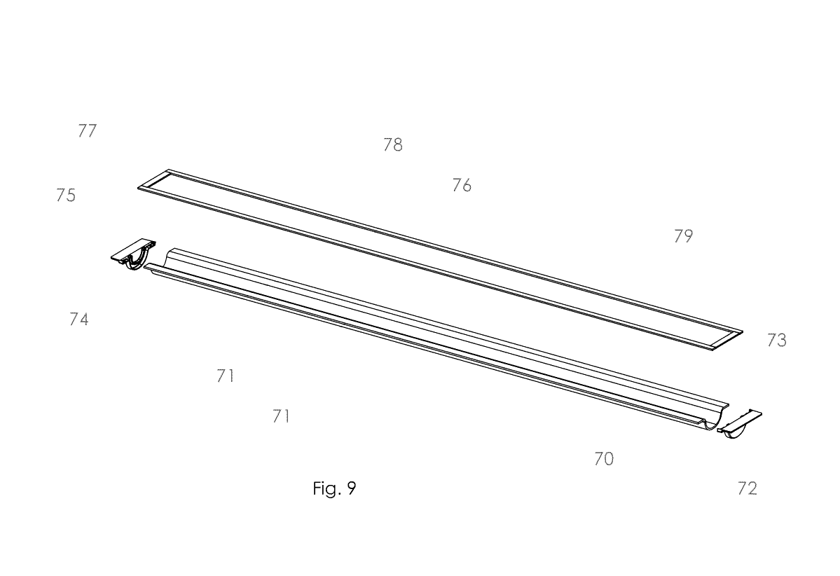

With reference now to FIGS. 8 and 9, a lens 70 is shown according to some embodiments. The lens 70 is configured to be attached to the second surface 14 of the support plate 10, such that the circuit board 60 and the LEDs 62 supported by the circuit board are disposed between the support plate 10 and the lens 70, as illustrated in FIG. 1A, for example. In this way, the lens 70 may serve to diffuse the light emitted by the LEDs to provide a more comfortable illumination of the space that is lit by the lighting fixture. The lens 70 may, for example be made of glass or plastic with sufficient surface energy to allow for adhesion. In the ultrasonic welding scenario, the lens and end caps must be of material that is similar enough to allow for the two materials to be welded together. For example, PP is generally not suitable for ultrasonic welding to PC, but PMMA (an acrylic) is generally well suited for welding to PC. In some cases, for example, the lens 70 may be made of extruded polycarbonate material or other plastic. In other embodiments, glass may be used to construct the lens, and in such cases the end cap may be adhered to the glass lens via epoxy. Glass, however, may be less desirable for use as the lens than plastic material as epoxy would be needed to adhere the end cap to it. In addition, the glass lens may be selected to deliver a similar toughness to a plastic lens; however, the use of plastic glass lenses would significantly increase the weight of the fixture, as compared to a PC or PMMA lens.

In this regard, two end caps 72, 74 may be provided that are configured to receive the respective ends of the lens 70. The end caps 72, 74 may, for example, be attached to the respective ends of the lens 70 via epoxy, adhesive, or ultrasonic welding. The lens 70 and/or end caps 72, 74 may be attached to the second surface 14 of the support plate 10 via adhesive, such as via adhesive strips. For example, two adhesive strips 76, 78 may be used to attach flanged lateral edges 71 of the lens 70 to the second surface 14 of the support plate 10, and two adhesive strips 77, 79 may be used to attach engaging edges 75, 73 of the end caps 74, 72, respectively, to the support plate. In the depicted embodiment, for example, the adhesive strips 77, 79 may be configured (e.g., sized and shaped) to adhere both the engaging edges 75, 73 of the end caps 74, 72 as well as a portion of the flanged lateral edge 71 near the respective ends of the lens 70 to the support plate 10 to achieve the assembled configuration shown in FIG. 8.

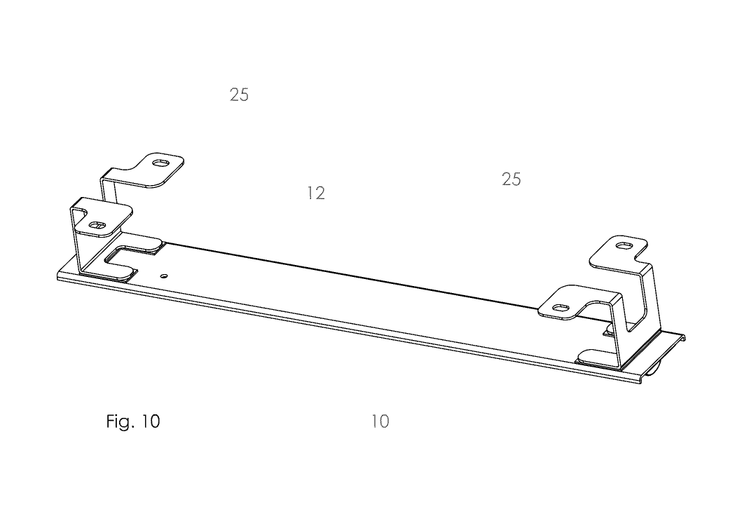

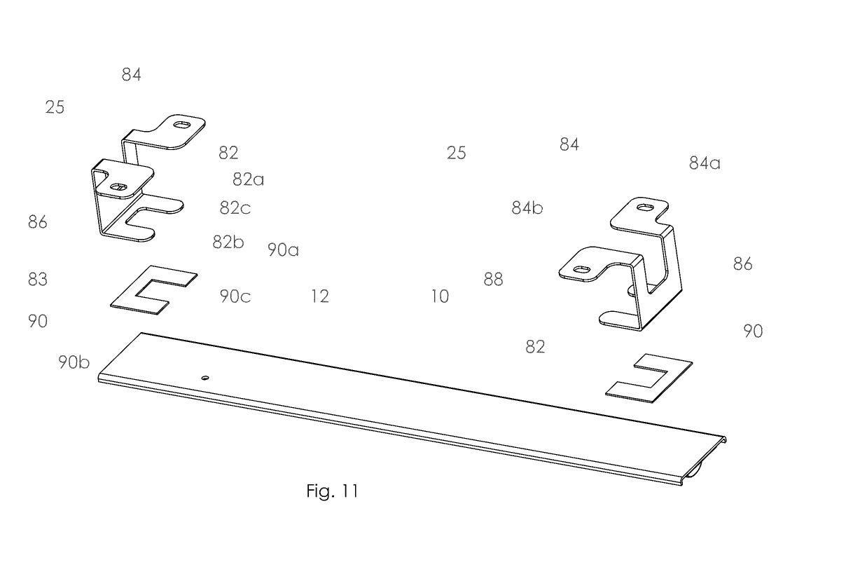

To facilitate installation of the lighting fixture 5 to a surface, such as a wall or ceiling, at least one mounting bracket 25 may be provided, which is attached to the support plate 10, as shown in FIG. 10, and is configured to secure the lighting fixture in an operational position. In the depicted embodiment of FIGS. 10 and 11, for example, two mounting brackets 25 are provided, and the mounting brackets are configured (e.g., sized and shaped) to be attached to the first surface 12 of the support plate 10. In other embodiments, however, the mounting brackets may be designed to be attached to the ends of the support plate or the second surface of the support plate. In still other embodiments (e.g., shown in FIG. 12), separate mounting brackets may not be provided, and the functionality of the mounting brackets may instead by incorporated into the support 10 plate itself, as described in greater detail below.

In the exploded view of FIG. 11, which illustrates embodiments in which two mounting brackets 25 are provided that are configured to be attached to the first surface 12 of the support plate 10, each mounting bracket 25 may be generally C-shaped, having a first extension 82 and a second extension 84 that extend approximately perpendicularly from opposite ends of a connecting portion 86. The first extension 82 may be configured to be attached to the first surface 12 of the support plate 10, such as via an adhesive sheet 90 that is cut to correspond (e.g., be similar size and shape) with the size and shape of an outward surface 83 of the first extension 82 of the corresponding mounting bracket. In the depicted embodiment, for example, the first extension 82 comprises two legs 82a, 82b and an adjoining portion 82c. Accordingly, the adhesive sheet 90 comprises two legs 90a, 90b and an adjoining portion 90c. In other embodiments, however, the first extension 82 may, for example, be configured as a solid sheet (e.g., square, rectangular, etc.), and the adhesive sheet 90 may be cut to match the size and shape of the first extension 82. In still other embodiments, the adhesive sheet 90 may comprise multiple strips that are adhered at certain locations of the first extension 82 to provide adequate surface area over which the first extension is adhered to the first surface 12 of the support plate 10 to maintain securement of the two components to each other.

In the depicted embodiment, the second extension 84 is also configured to have two legs 84a, 84b. Each leg 84a, 84b of the second extension 84 may define an opening 88, which may be configured to receive a fastener therethrough, such as a nail, screw, bolt, etc. The opening 88 may, in some cases, be oblong in shape, such as to form a slot, thereby providing additional tolerance in the positioning of the fastener through the opening to attach to an appropriate location on the structure (e.g., ceiling or wall) to which the lighting fixture is being mounted. Although the second extension 84 is configured to have two legs 84a, 84b in the embodiment shown in FIG. 11, in other embodiments the second extension may be formed differently, such as by having a single leg or to being in the form of a solid plate that can be mounted to the ceiling or wall.

According to the embodiments described above, a lighting fixture may be manufactured in which several of the components, and in some cases all of the components, that make up the lighting fixture are held together without the use of mechanical fasteners. Rather, in embodiments described above, pieces of adhesive tape that are cut to have various sizes and shapes according to the size and shape of the components to be adhered to each other may be used to secure the components in an assembled configuration. In some cases, for example, a high-strength double-sided bonding tape such as 3M™ VHB™ tape may be used. As noted above, the sizing and positioning of the tape between certain components may not only eliminate or reduce the need for conventional mechanical fasteners for those components, but also may also eliminate the need to use a separate gasket or seal between those components. In this regard, the adhesive itself may form the seal, and the resulting lighting fixture may be categorized as an IP (Ingress Protection) 67-rated luminaire, which is dust tight (level 6) and is liquid tight (level 7) up to submersion in 1 meter of water. In addition, adhesive may be used in certain locations that is able to withstand operating temperatures of approximately −40° C.-+70° C. and, in some cases, may facilitate the dispersion of heat from components such as the circuit board and LEDS by acting as a thermal interface and conduit, thereby maximizing the operating life of the lighting fixture.

In some embodiments, a method of manufacturing a lighting fixture is thus provided, in which a housing (e.g., a housing configured to receive a power supply, such as a power electronics housing) is attached to a first surface of a support plate, as described above. A plurality of LEDs may be connected to a circuit board, and the circuit board may be attached to a second surface of the support plate. A lens may be attached to the second surface of the support plate, such that the circuit board and the LEDs supported thereby are disposed between the support plate and the lens. In addition, at least one mounting bracket may be attached to the support plate, where the at least one mounting bracket is configured to secure the lighting fixture in an operational position. The attachment of each of the housing, the lens, and the mounting bracket to the support plate can be accomplished without the use of mechanical fasteners, as described above, and the attachment of each of the housing and the lens to the support plate may provide a watertight fixture. As described above, for example, the housing, the circuit board, the lens, and the at least one mounting bracket may be attached to the support plate by applying adhesive strips to adhere each of the housing, the circuit board, the lens, and the at least one mounting bracket to the support plate.

In some cases, the power supply may be attached to the first surface of the support plate prior to attaching the housing to the support plate. Moreover, in some embodiments, an access opening may be created in the support plate, where the access opening is configured to allow passage of electrical wiring from the power supply to the circuit board. In some cases, the access opening may, for example, be a first access opening, and a second access opening may be created in the support plate to allow passage of electrical wiring from the power supply to a second lighting fixture, such that the power supply is enabled to provide power to multiple lighting fixtures. In addition, in some embodiments, an end cap may be attached to each end of the lens via ultrasonic welding, epoxy, or adhesive.

Embodiments of the lighting fixture 5 described above with reference to FIGS. 1A-11 include a support plate 10, a housing 15, a circuit board 60, a lens 20, and at least one mounting bracket 25. In such embodiments, as described above, two or more lighting fixtures 5 may be wired in “daisy chain” fashion (e.g., in series), where leads from trailing end terminals of the circuit board of the first lighting fixture is passed through a second access opening in the support plate 10 and routed to leading end terminals of the circuit board of the adjacent lighting fixture, such that a single power supply (e.g., of the first lighting fixture) is used to power multiple circuit boards.

In other embodiments, such as shown in FIGS. 12A-13, a lighting fixture 100 may be provided that has a support plate 110 sized to accommodate multiple circuit boards arranged and wired in parallel (e.g., side-by-side on the same support plate). Thus, for the parallel scenario, the support plate 110 may be wider as compared to the support plate 10 of FIGS. 1A and 1B, such as to support, for example, three circuit boards, as in the embodiment of FIGS. 12A-13. In addition, the housing 115 of the lighting fixture 100 (FIG. 12B) may be proportionally wider to allow access holes 117 (shown in FIG. 13, in which the housing 115 is removed for purposes of explanation) for routing wiring to the various boards to be defined in the support plate 110, while still covering the holes and providing a protected environment between the housing (on top) and a respective lens assembly 120 (on the bottom).

Embodiments of the lighting fixture 100 of FIGS. 12A-13 may include a single power supply 140 or multiple power supplies within the housing 115. Moreover, although multiple lenses 120 are shown in FIG. 12 (e.g., one for each circuit board), a single lens (e.g., sized wider) may be used in some cases to cover multiple circuit boards, in which case it may be possible to “daisy chain” those boards, as described above with respect to the series scenario described with reference to the embodiments of FIGS. 1A-11.

Furthermore, although the embodiment of FIGS. 1A-11 includes separate mounting brackets 25, embodiments of the lighting fixture 100 configured as shown in FIGS. 12A-13 may not need separate mounting brackets 25. Instead, the lighting fixture 100 may be configured to be flush-mounted to a structure's ceiling via mounting holes 125 defined directly into the support plate 110. In this regard, the mounting holes 125 may be configured to receive fasteners (e.g., screws, bolts, etc.) for securing the support plate 110 to the ceiling. The components (e.g., the housing 115, circuit board, lens 120, power supply 140, etc.) of the lighting fixture 100 depicted in embodiment of FIGS. 12A-13 may be attached to the support plate 110 in the same manner described above with respect to the embodiments of FIGS. 1A-11, without the use of mechanical fastening, such as via adhesive (e.g., adhesive tape).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, although only certain components and configurations (e.g., arrangements of circuit boards/lenses) are shown in the figures and described above, it is understood that additional components may be included for enhancing the functionality and/or improving the performance of the lighting fixture. In the embodiment illustrated in FIG. 12B, for example, an optional back-up battery 130 is included that is configured to provide emergency lighting in the event of a black-out or interruption of electrical power. Such additional components may be attached to the support plate 110 without the use of mechanical fastening, such as via adhesive, as described above with respect to other components of embodiments of the lighting fixtures 5, 100, to provide for a watertight and light-weight lighting fixture.

Although specific terms are employed herein, they are used in a generic and descriptive sense only and not for purposes of limitation.

What is claimed is:

1. A lighting fixture comprising:
a support plate comprising a first surface and a second surface;
a housing configured to receive a power supply, wherein the housing is attached to the first surface of the support plate;
a circuit board configured to support a plurality of light emitting diodes, wherein the circuit board is attached to the second surface of the support plate; and
a lens attached to the second surface of the support plate, such that the circuit board and the light emitting diodes supported thereby are disposed between the support plate and the lens,
wherein the attachment of each of the housing and the lens to the support plate is accomplished without the use of mechanical fastening, and
wherein the attachment of each of the housing and the lens to the support plate provides a watertight lighting fixture.

2. The lighting fixture of claim 1, wherein the attachment is accomplished using adhesive.

3. The lighting fixture of claim 1, wherein the attachment of the circuit board to the support plate is accomplished without the use of mechanical fastening.

4. The lighting fixture of claim 3, wherein the attachment is accomplished using adhesive.

5. The lighting fixture of claim 1 further comprising at least one mounting bracket attached to the support plate, wherein the at least one mounting bracket is configured to secure the lighting fixture in an operational position, and wherein attachment of the mounting bracket to the support plate is accomplished without the use of mechanical fastening.

6. The lighting fixture of claim 1, wherein the support plate defines at least one mounting hole, each mounting hole being configured to receive a fastener for flush-mounting the lighting fixture to a ceiling.

7. The lighting fixture of claim 1, wherein the support plate comprises an access opening configured to allow passage of electrical wiring from the power supply to the circuit board.

8. The lighting fixture of claim 5, wherein the access opening is a first access opening, wherein the support plate further comprises a second access opening configured to allow passage of the electrical wiring from the power supply to a second lighting fixture, such that the power supply is enabled to provide power to multiple lighting fixtures in series.

9. The lighting fixture of claim 1, wherein the power supply is attached to the first surface of the support plate via adhesive.

10. The lighting fixture of claim 1 further comprising two end caps configured to receive respective ends of the lens.

11. The lighting fixture of claim 10, wherein each end cap is attached to the second surface of the support plate via adhesive and is attached to the respective end of the lens via ultrasonic welding, epoxy, or adhesive.

12. The lighting fixture of claim 1, wherein the housing comprises a U-shaped body and two end plates, wherein each end plate is attached to a respective end of the U-shaped body to form an enclosure of the housing, and wherein each end plate is attached to the respective end of the U-shaped body via adhesive.

13. A method of manufacturing a lighting fixture comprising:
attaching a housing to a first surface of a support plate, wherein the housing is configured to receive a power supply;
connecting a plurality of light emitting diodes to a circuit board;
attaching the circuit board to a second surface of the support plate; and
attaching a lens to the second surface of the support plate, such that the circuit board and the light emitting diodes supported thereby are disposed between the support plate and the lens,
wherein the attachment of each of the housing and the lens to the support plate is accomplished without the use of mechanical fastening, and
wherein the attachment of each of the housing and the lens to the support plate provides a watertight lighting fixture.

14. The method of claim 13 further comprising attaching the power supply to the first surface of the support plate prior to attaching the housing to the support plate.

15. The method of claim 13, wherein attaching the housing, the circuit board, and the lens to the support plate comprises applying adhesive strips to adhere each of the housing, the circuit board, and the lens to the support plate.

16. The method of claim 13 further comprising attaching at least one mounting bracket to the support plate, wherein the at least one mounting bracket is configured to secure the lighting fixture in an operational position, and wherein attachment of the mounting bracket to the support plate is accomplished without the use of mechanical fastening.

17. The method of claim 13 further comprising creating at least one mounting hole in the support plate, wherein the mounting hole is configured to receive a fastener for flush-mounting the lighting fixture to a ceiling.

18. The method of claim 13 further comprising creating an access opening in the support plate, wherein the access opening is configured to allow passage of electrical wiring from the power supply to the circuit board.

19. The method of claim 18, wherein the access opening is a first access opening, the method further comprising creating a second access opening in the support plate to allow passage of the electrical wiring from the power supply to a second lighting fixture, such that the power supply is enabled to provide power to multiple lighting fixtures.

20. The method of claim 13 further comprising attaching an end cap to each end of the lens via ultrasonic welding, epoxy, or adhesive.
